(19) United States
(12) Patent Application Publication
(10) Pub. No.: US 2008/0121601 A1
(43) Pub. Date: May 29, 2008

(54) Hoist Device

(76) Inventor: Franz Ehrenleitner, Thomasroith (AT)

Correspondence Address: FRIEDRICH KUEFFNER, 317 MADISON AVENUE, SUITE 910, NEW YORK, NY, 10017, US

(21) Appl. No.: 11/667,027

(22) PCT Filed: Oct. 28, 2005
(86) PCT No.: PCT/AT05/00429

§ 371 Date: Jun. 5, 2007

(30) Foreign Application Priority Data
Nov. 2, 2004 (AT) A 1831/2004

(51) Int. Cl. B66C 21/04

(52) U.S. Cl. 212/76

(57) ABSTRACT

The invention relates to a hoist device, in particular, for the automobile industry, comprising an upper frame (1) and a lower frame (2), arranged below the above, whereby the lower frame (2) is held on the upper frame (1) by means of at least three essentially vertically-running ties (3) and at least four tensioning means (4), at an angle to the vertical, such as to be vertically displaced by means of powering the ties (3) and the tensioning means (4). Pairs of tensioning means (4) at least approximately engage at a common point (5) on the lower frame (2). According to the invention, the pivoting may be simplified and improved, whereby the ends of the two tensioning means (4) pass over a joint (14) connected to the lower frame (2), permitting the rotation of the lower frame (2) relative to the tensioning means (4) about a rotational axis (15), given by both engagement points (5) of the tensioning cables (4) on the lower frame (2).

The invention concerns a hoisting machine, especially for the automobile industry, with an upper frame and a lower frame positioned below it, where the lower frame is held on the upper frame by traction elements and possibly tensioning elements that run obliquely to the vertical and can be moved vertically by driving the traction elements and tensioning elements.

Hoisting machines are used to lift and convey heavy loads, especially vehicle bodies in the automobile industry, and therefore must be able to withstand high stresses. Hoisting machines of this type are movably mounted on rails that project downward from the ceiling of factory buildings and convey the vehicle bodies that are being produced from one manufacturing operation to the next. In most cases the hoisting machine and its load are suspended above the heads of many workers, who are performing work on the underside of the automobile body, such as welding, assembly, wiring, etc.

A hoisting machine of this type is described, for example, in EP 1 106 563 B1. It consists of an upper frame, a lower frame, and traction cables, which are connected to a drive, arranged between them. The traction cables are guided over guide sheaves onto a motor-driven drum. In addition to cables that run only vertically, there are cables that run at an angle to the vertical over part of their course. A cable of this type runs obliquely from the upper frame to the lower frame, is deflected by a sheave, and then runs vertically towards the upper frame, where it is then connected to the same drive that is used for the vertical cables. These cables with oblique sections serve the purpose of increasing the stability of the lower frame and of the load suspended from it. In the event of a cable break, to prevent the load held by the hoisting machine from falling and crushing a man who is working beneath it, a double vertical cable guide is proposed. The load can be prevented from falling by additional cables, guide sheaves and suspensions, but at the same time this increases the dead weight of the hoisting machine and thus the manufacturing, installation and maintenance costs as well.

DE 23 19 647 discloses a crane for lifting loads. In this crane, a loading platform, on which the load to be conveyed is mounted, is suspended on hoisting cables, whose suspension points are located in the bogie truck of the crane. In addition to the hoisting cables, stabilizer cables are provided, which are guided to a cable drum and run obliquely to both the longitudinal direction and the transverse direction. The loading platform itself is rectangular, and all cables, i.e., both stabilizer and lifting cables, are attached to the corner regions of the loading platform. This construction is designed to allow exact positioning of a load without causing large oscillatory movements. Rotation of the load about a horizontal axis is not intended and would be possible only with difficulty and to a limited extent with a machine of this type. All of the cables and cable lengths would have to be coordinated with one another in a strictly defined way in a maneuver of this type.

U.S. Pat. No. 4,705,180 discloses a hoisting machine that consists of vertically arranged traction cables and, in addition, four stabilizer cables that run essentially along the edges of a pyramid to the loading platform. As in the preceding document, all of the cables are attached to the corner regions of the loading platform. Rotation around a horizontal axis is not intended for a machine of this type and is also not possible, since all four traction cables are wound on the same cable drum.

U.S. Pat. No. 5,769,250 (or the corresponding document EP 0 793 615 B1) discloses a hoisting machine in which a loading platform can be raised or lowered by means of cables. All of the cables acting in this machine are oriented at an angle to the horizontal, and each traction element, which consists of a sheave mounted on the loading platform and a revolving cable, is attached to one of the corner regions of the loading platform. Two additional cable sheaves, around which the additional stabilizer cables run, are located near the shorter sides of the loading platform between the cable sheaves arranged in the respective corner regions. The machine disclosed in this document is based on the use of four identical but mechanically independent control mechanisms; the control is based on the distance information of each stabilizer cable and the speed of rotation of the motor connected to the stabilizer cable or the drum. Oscillations arising in a horizontal plane can be damped by a machine of this type, but rotation of the loading platform about a horizontal axis is not possible and, of course, is not intended.

Hoisting machines must meet a number of requirements in order, on the one hand, to be efficient and, on the other hand, to be able to comply with legally prescribed safety regulations. Furthermore, the manufacture of hoisting machines of this type must be cost-effective and not overly complicated. The following properties are required:
the lower frame, along with the hanger mounted on it for holding automobile bodies, must have a high degree of stability with respect to the forces acting on it, for example, those caused by acceleration or deceleration during transfer to the next manufacturing operation, human muscle force, forces and vibrations produced by tools or other factory components (manipulators);
the overall height should be small in the retracted state, but the hoisting height should be large;
there should be a high degree of security against the load falling, since in most of the manufacturing operations, men are working next to or below the hoisting machine or the load it is supporting;
the dead weight should be as low as possible, but the machine should still be able to move large masses;
the manufacturing, installation, and maintenance costs of the hoisting machine should be favorable;
the hoisting speed should be as close to linear as possible, which also makes it possible to use motors that have lower outputs and are thus more cost-effective;
the hoisting movement should be as close as possible to the vertical direction; and
additional advantages should also be provided for the user, e.g., the possibility of rotational movement of the lower support frame about one of the two horizontal space axes.

Efforts to achieve greater safety are becoming more and more important. Instead of additional safety cables, mechanical braking systems similar to those used in elevators or completely redundant systems are also often used. Mechanical catching or braking systems are not always reliable for loads of several tons, however, and in the case of redundant systems, the same elements are merely installed in duplicate. Due to the wear phenomena that affect both systems of elements in the same way, there is a high probability that if one system fails, the other system can no longer reliably perform its function either, so that the danger of a load being dropped can hardly be reduced in this way.

There is a need for a heavy-load hanger, especially for automobile final assembly, which, because of its low overall height in the retracted state, its low dead weight, and its favorable price, offers a market advantage over the known lifting hangers. It is intended that this advantage be increased by making it possible, when necessary, to rotate the lower frame about a horizontal axis, e.g., the longitudinal axis of an automobile (at least up to an angle of 60°). Rotation around the longitudinal axis of the vehicle is usually important in vehicle final assembly, and rotation around an axis transverse to the longitudinal axis of the vehicle is important in vehicle painting.

The task of the present invention is to achieve the stated goals and to avoid the problems of the prior-art devices of this type by proposing a hoisting machine which guarantees a high degree of stability of the lower frame, together with the support frame, towards forces acting on them, has a low dead weight, provides the best possible safety for the men working near the hoisting machine, and can be rotated around a horizontal axis. It is intended that a machine of this type can realize large angles of rotation and that complicated automatic control mechanisms can be avoided by a simple basic design. In particular, the slackening of traction elements is to be prevented.

In accordance with the invention, these goals are achieved with a hoisting machine of the previously mentioned type in that pairs of tensioning elements are attached, at least approximately, to a common point on the lower frame, where the ends of the two tensioning elements terminate at a joint connected to the lower frame. This joint allows rotation of the lower frame relative to the tensioning elements around an axis of rotation which is defined by the two points of attachment of the pairs of tensioning cables to the lower frame. The lower frame may also be considered to include all extensions, upwardly or downwardly projecting mounts, etc., on which, of course, the joint of the invention can also be positioned.

This measure makes it possible to achieve rotation of the lower frame without it being necessary for the length of individual tensioning cables to change. This greatly simplifies the rotation, and at the same time, all of the advantages inherent in the oblique tensioning cables can be fully exploited. The term “at least approximately” means that slight deviations from a common point of attachment are permissible as long as the tensioning cables do not become slack during the rotation. In the case of slight deviations from a point of attachment, the natural stretch of the tensioning cables and the change in their length that results from their natural stretch must at least partially compensate for the changes in position of the ends of the cables with respect to the direction of the cable.

In one variant of the invention, the drive of the traction elements is connected hydraulically to a pressure accumulator. This allows effective damping in the event of shocks and collisions.

In one embodiment, the drive for the traction cables and the drive for the tensioning cables are hydraulically connected to each other with respect to the energy supply via a pressure accumulator. They are thus mechanically isolated from each other with respect to rotation, but they can be supplied by the same energy source.

In another embodiment, the drive for the traction cables and the drive for the tensioning cables are completely separate from each other.

As a result of the mechanical isolation of the two drives, two independent systems are created; the system of traction elements consisting of vertical traction elements is used to lift and lower the load, while the system consisting of the oblique tensioning elements ensures sufficient stability of the lower frame and the load suspended on it. When wear phenomena cause a partial or total failure of the system of traction elements, the system consisting of oblique tensioning elements, i.e., the oblique cables, is immediately able to support the load, so that the load can be prevented effectively from falling. Although this measure requires only a separate drum with an associated drive, e.g., an electric motor, the system meets the same safety standards and in many cases even higher safety standards than prior-art hoisting machines equipped with complicated and redundant safety systems.

When the drives are completely separate, a first motor is used to drive the vertical cables, while the second motor is used to unwind the oblique cables or tensioning cables. In contrast to the first motor, this drive does not have a constant speed ratio between the hoisting movement and the rotary drive. However, since only small forces need to be transmitted during normal operation, this is not a problem. By contrast, the speed ratio of the first motor is constant, and this results in the lowest possible drive power. To control the second drive, i.e., the drive for the tensioning cables, either a two-axis control system can be used, or the tensioning cables can be maintained at constant tension by suitable readjustment on the basis of the detection of the movement of two elements relative to each other, e.g., two elements connected by a pretensioned spring, for example, by inductive measurement. If the hoisting motor fails, the second motor can then hold the load. The only requirements are traction elements that can withstand sufficiently large loads, a reliable gearbox, and suitably designed brakes. It is not necessary for the second motor to be able to lift the load.

In an especially preferred embodiment of the invention, the hoisting machine is characterized in that at least one vertical traction element has a drive that is independent of the other vertical traction elements for tilting the lower frame. This means that the system of vertical traction elements has two or more motors, which is to say that, for example, two traction elements are wound by a single motor, while the others are driven by another motor. In principle, it is possible for all of the traction elements to have their own separate motors, which allows tilting in all directions. The rotation or tilting of the lower frame in this case resembles the manipulation of a marionette suspended by strings.

In another embodiment, at least one tensioning element that runs obliquely to the vertical has a drive that is independent of the other tensioning elements that run obliquely to the vertical. When the load is tilted by several independently controlled drives in the system of traction elements, this measure makes it possible to maintain the necessary tension in all of the tensioning elements without one of the tensioning elements becoming slack.

In a preferred variant, the system consisting of the upper frame, lower frame, traction elements, and tensioning elements is kinematically determined and preferably kinematically overdetermined. This guarantees stability with respect to forces acting horizontally on the lower frame and with respect to rotation around the vertical.

In an especially preferred variant, the tensioning elements are attached at two points to the lower frame, such that the line connecting the two points of attachment passes essentially through the vertical projection of the center of gravity of the lower frame onto the horizontal plane that contains the points of attachment.

In one embodiment, the tensioning elements are attached to the lower frame at least three points, and the outer outline of the three or more points of attachment encloses the vertical projection of the center of gravity of the lower frame onto the horizontal plane that contains the points of attachment.

In another embodiment, the outline of the tensioning elements vertically projected onto the horizontal plane of the center of gravity of the lower frame contains the center of gravity of the lower frame.

As a result of these measures, in the event of a failure of the system of traction elements, the load cannot rotate significantly but rather remains essentially in its original position.

The invention is explained in greater detail below with reference to the drawings.

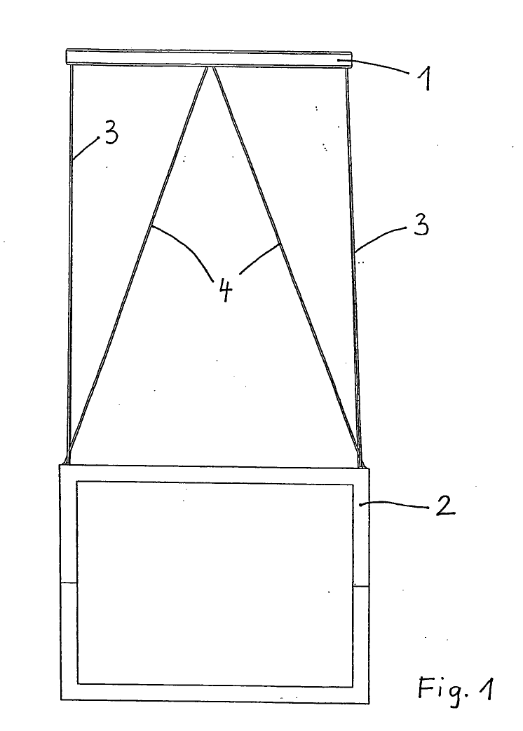

FIG. 1 shows a side view of a hoisting machine with tensioning cables arranged between vertical cables.

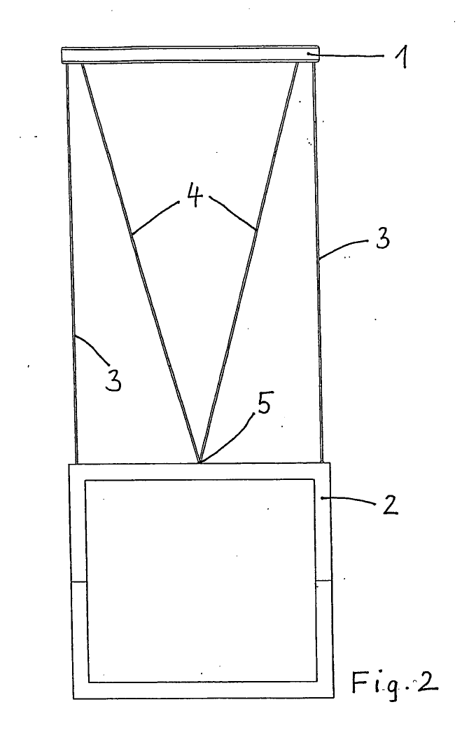

FIG. 2 shows the same hoisting device turned 90°.

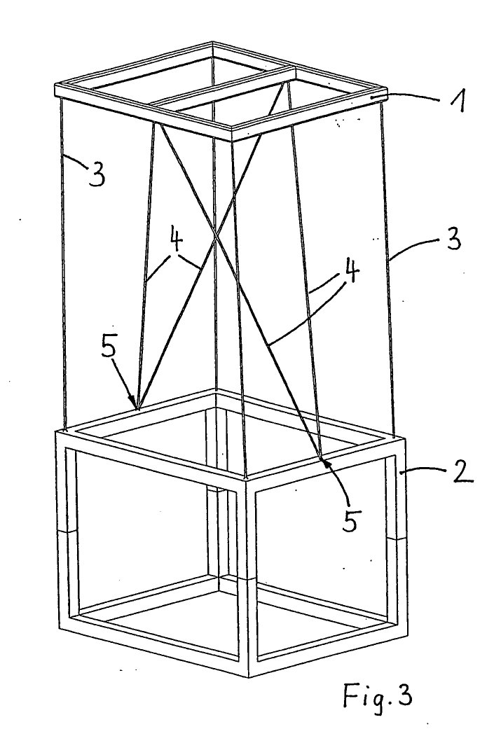

FIG. 3 is a three-dimensional representation of the hoisting machine.

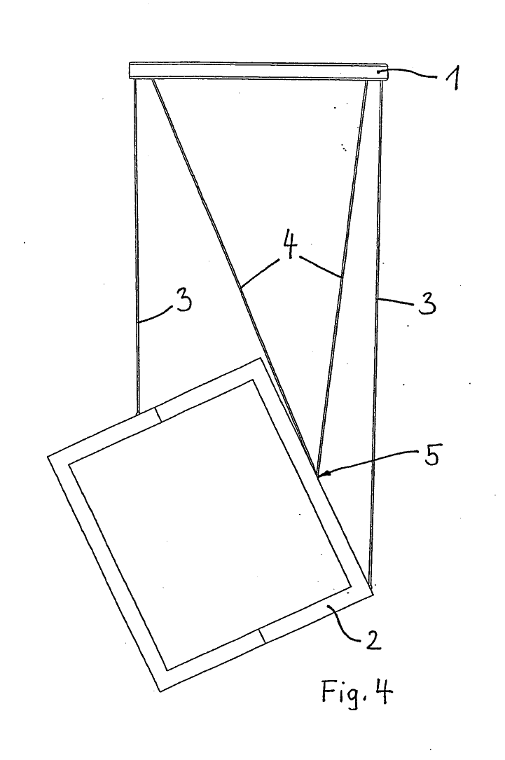

FIG. 4 shows a side view of a hoisting machine with the lower frame tilted.

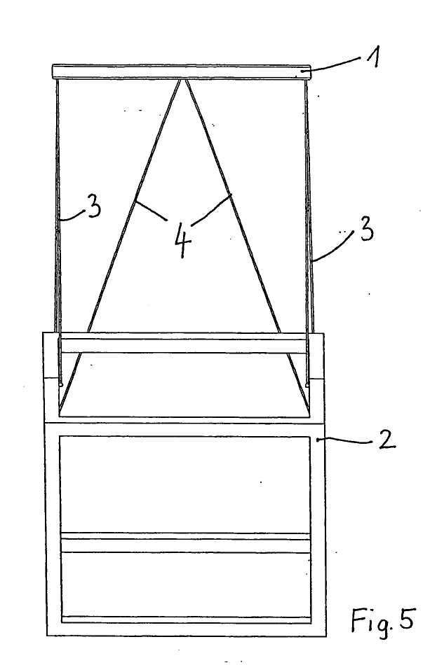

FIG. 5 shows the hoisting device of FIG. 5 turned 90°.

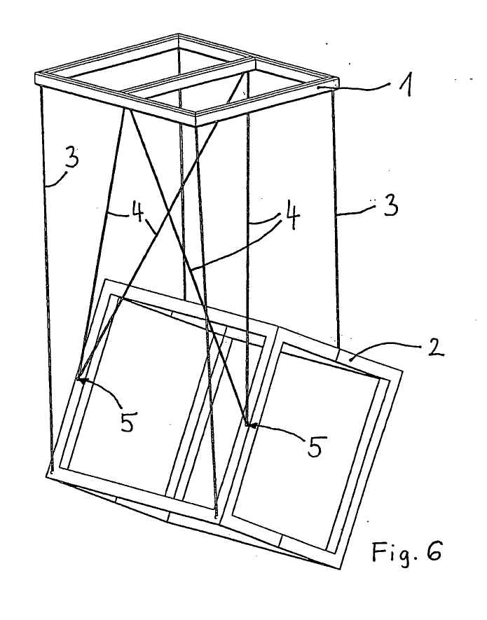

FIG. 6 is a three-dimensional representation of the hoisting device of FIG. 5.

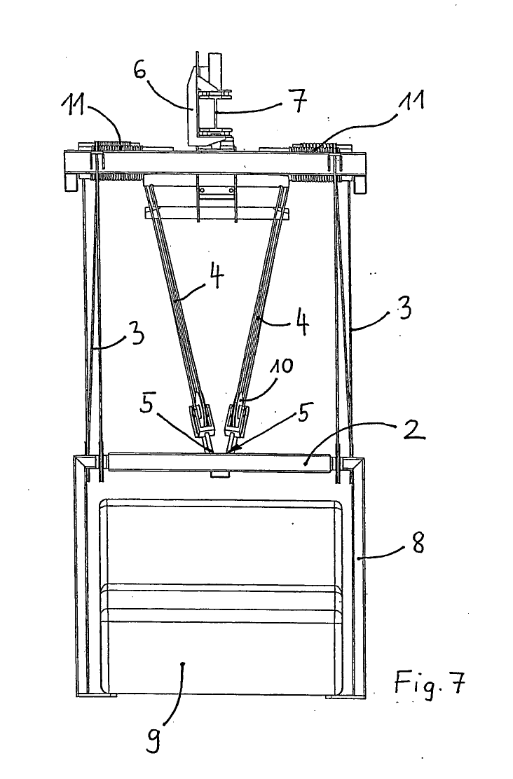

FIG. 7 shows a detail side view of a hoisting machine.

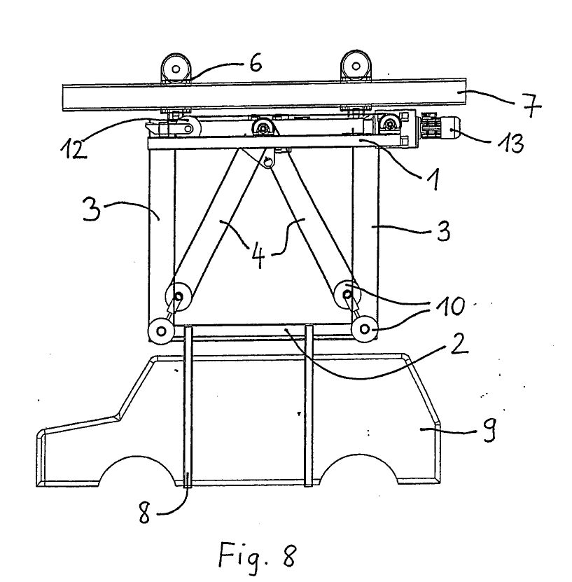

FIG. 8 shows the hoisting machine of FIG. 7 turned 90°.

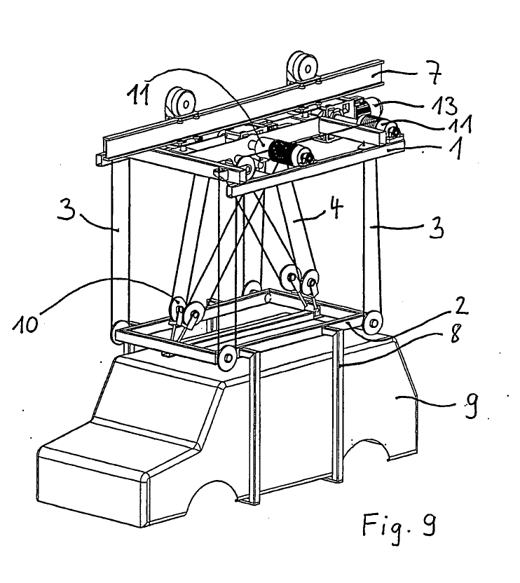

FIG. 9 is a three-dimensional representation of the hoisting machine of FIG. 7.

FIG. 10 shows a hoisting machine with four motors.

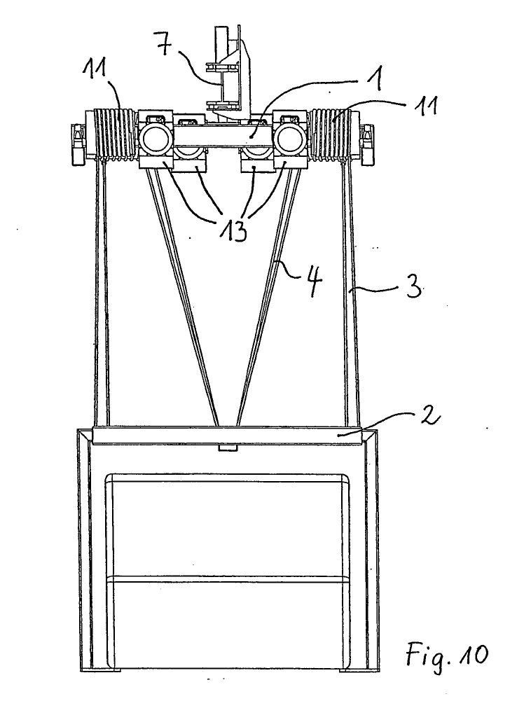

FIG. 11 shows the hoisting machine of FIG. 10 turned 90°.

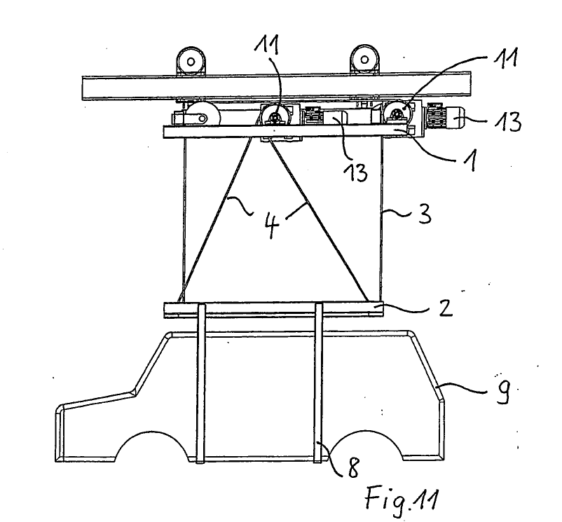

FIG. 12 is a three-dimensional representation of a hoisting machine with four motors.

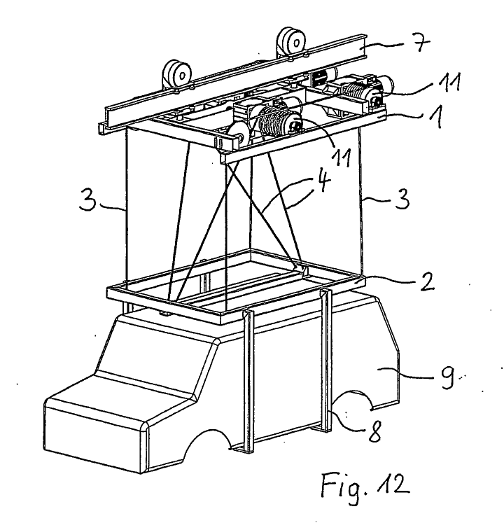

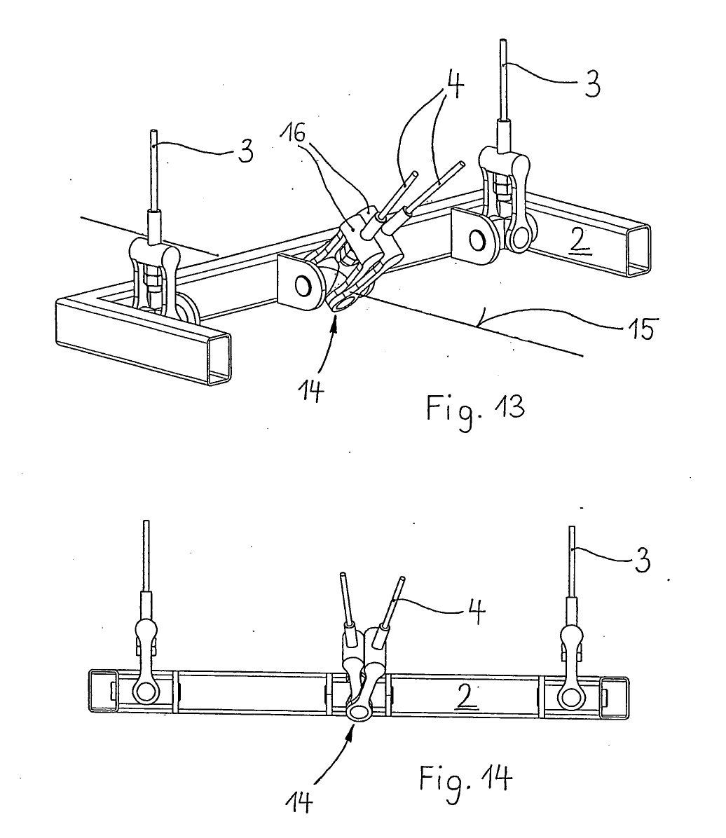

FIGS. 13 to 16 show detail views of a hoisting machine.

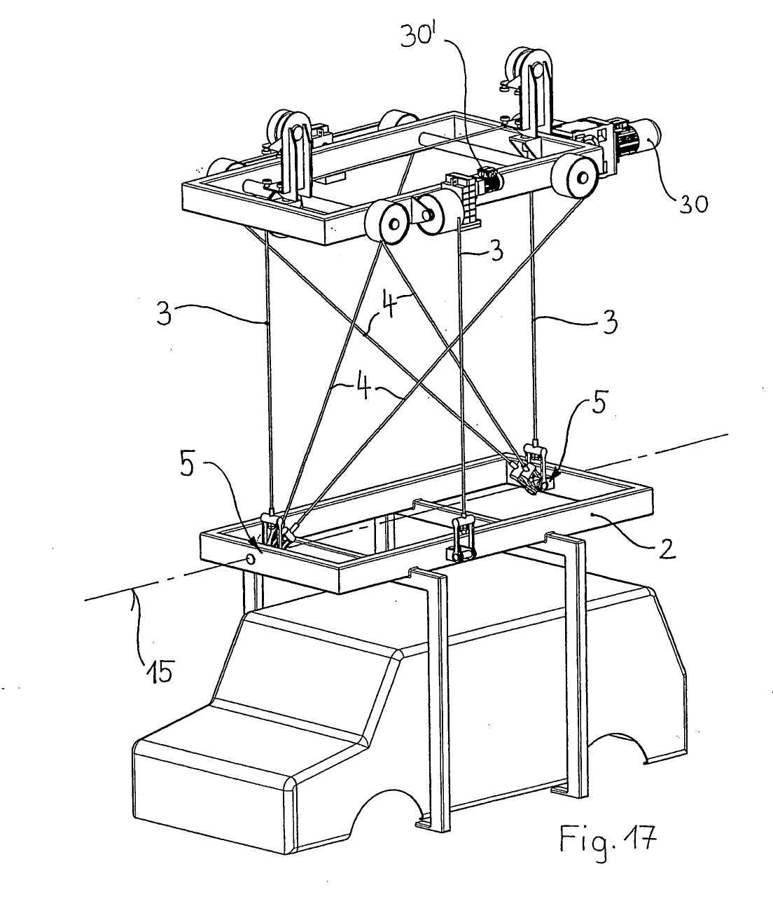

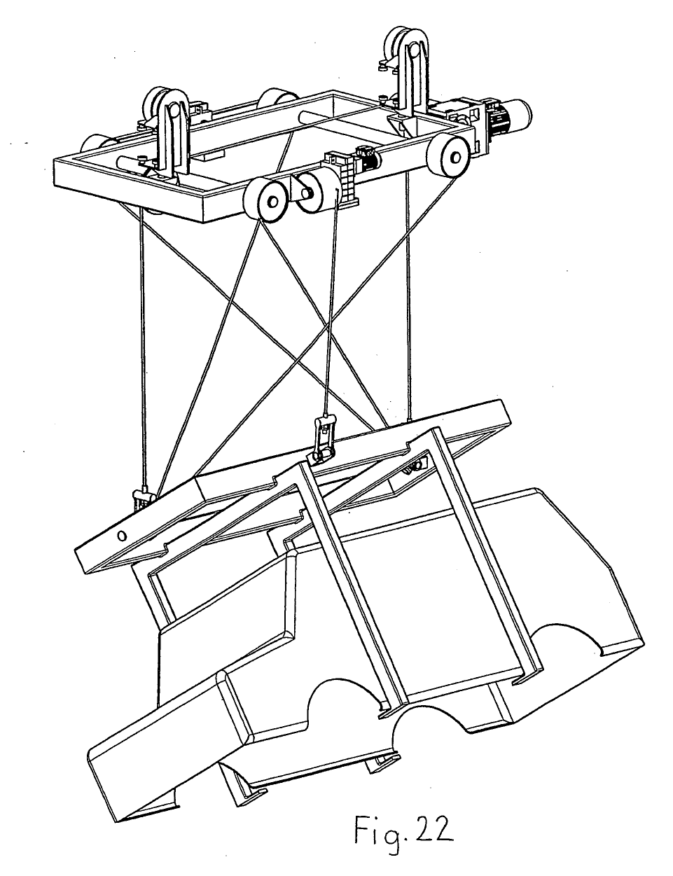

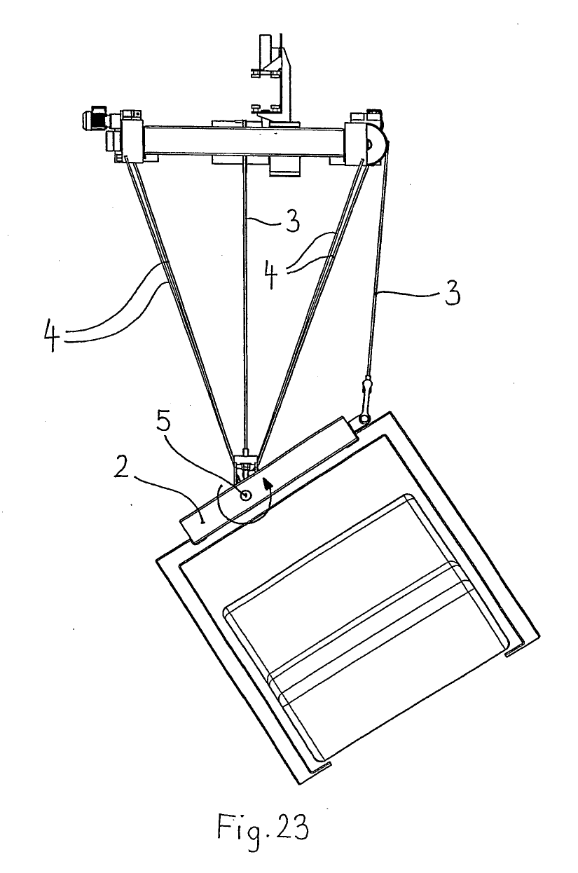

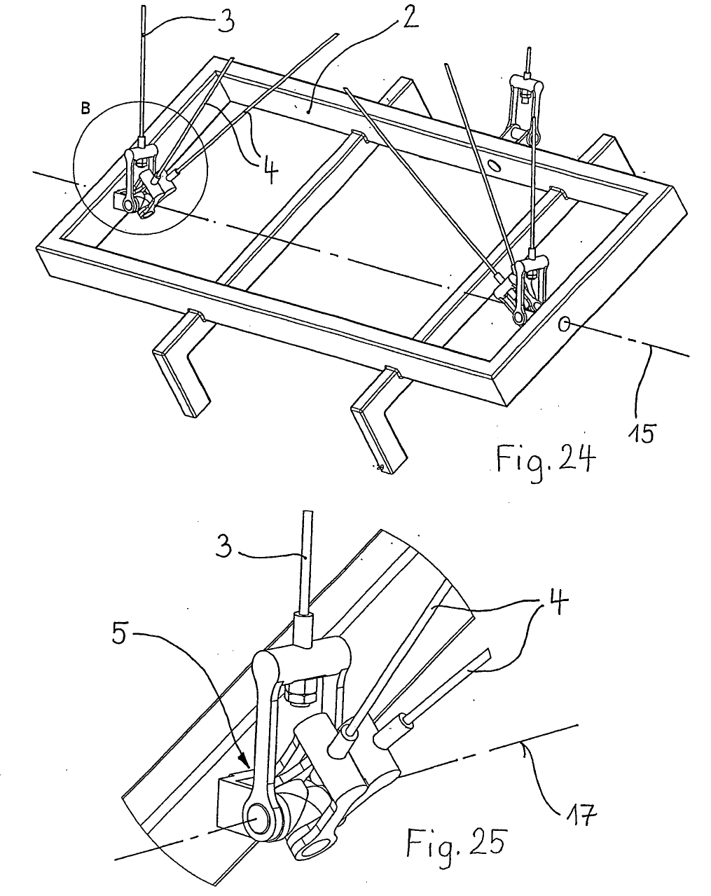

FIGS. 17 to 25 show a variant of the invention.

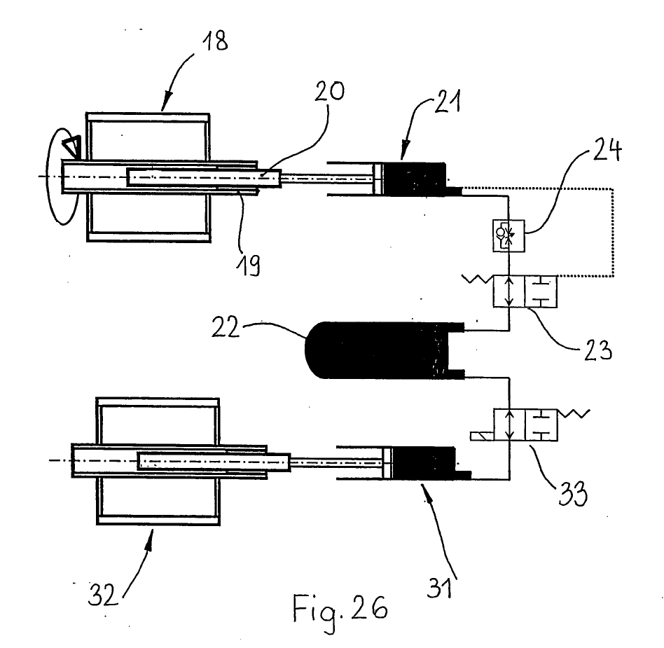

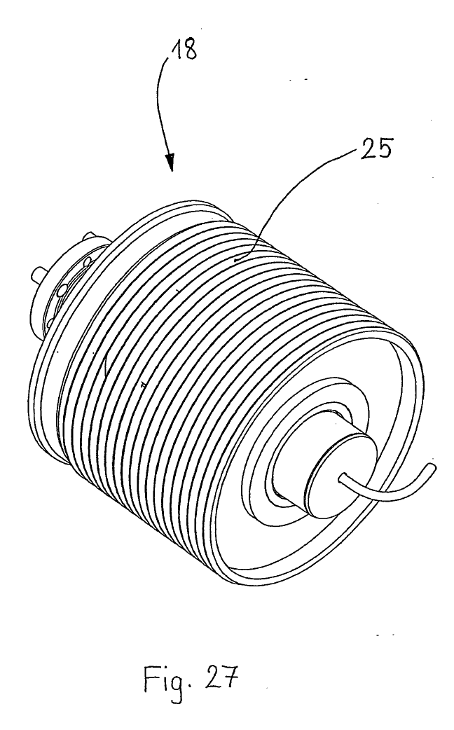

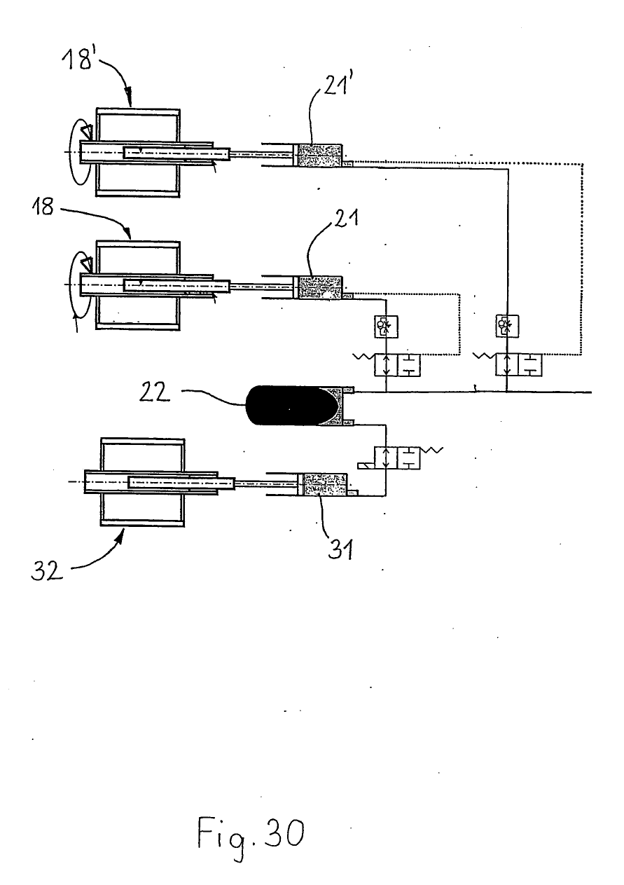

FIGS. 26 to 30 show a preferred embodiment of the invention.

FIGS. 1, 2 and 3 are schematic diagrams (without the guide sheaves, drums, and motors) of a hoisting machine with an upper frame 1 and a lower frame 2, which is positioned below the upper frame 1 and is supported by cables 3, 4 from the upper frame 1. FIGS. 1 to 3 show the hoisting machine in different viewing directions. The upper frame 1 can be provided with a suspension 6 that can travel on a corresponding rail 7, as indicated in FIG. 7, or it can be mounted directly on the ceiling of an assembly building. The frames 1, 2 are usually quadrilateral, but they could also be triangular, rounded, circular, oval, or any other desired shape and could possibly be provided with struts. They can be realized as a three-dimensional framework and/or they can be connected integrally to the support frame 8.

The cable system consists of a group of essentially vertical cables 3 and a group of cables 4 that run at an angle to the vertical. To prevent downward tilting of the lower frame 2, i.e., rotation around a horizontal axis, the group consisting of vertical cables 3 must have at least three cables that are attached to the vertices of a triangle. Of course, the use of four or more vertical cables 3 is preferred for reasons of safety and stability, but also because quadrilateral, preferably rectangular, lower frames are used almost exclusively in industry. The traction cables 3 are preferably attached near the corners or near the outer edges of the frames 1, 2 and are arranged in such a way that, when a load is being supported, all of the traction cables are supporting essentially the same load. The center of gravity of the structure supported by the cables, which consists of the support frame 8 for the load and the load 9 itself, is located essentially below the center of gravity of the lower frame 2.

The cables 4 that run obliquely to the vertical are also referred to as tensioning cables. Their purpose is to increase the stability of the hoisting machine with respect to forces acting on the lower frame 2 or the support frame 8 for the load and thus to suppress the swinging or oscillation of the lower frame 2 with respect to the upper frame 1. These kinds of forces arise, for example, due to acceleration and deceleration during a move from one workstation to the next under the influence of the inertia of a load that weighs several tons. Forces transmitted by men or tools have a much smaller effect.

Movement of the lower frame 2 in horizontal directions and rotation around the vertical axis are suppressed by the tensioning cables 4 that are obliquely oriented relative to the vertical. The group consisting of the obliquely tensioned cables 4, which must have adequate pretensioning force, must also comprise at least three cables, which are attached to the lower frame 2 at least two points of attachment 5. Each of the three tensioning cables 4 must lie in a different vertical plane. For example, they can run as shown in FIG. 3, in which case any one of the four cables 4 could be omitted. To prevent rotation around the vertical, at least two points of attachment 5 that are spaced as far apart as possible must be provided both on the lower frame 2 and on the upper frame 1.

The three vertical cables 3 prevent rotation around the horizontal axes and displacement along the vertical axes, while the three oblique tensioning cables 4 suppress movement in the horizontal directions and rotation around the vertical axes. A system of this type is also referred to in the field of mechanics as kinematically determined.

As explained above for the group of vertical cables 3, four or more cables are also preferred for the group of oblique cables 4 for the same reasons. Each set of two tensioning cables 4 can lie in the same plane. As FIG. 3 shows, the tensioning cables 4 constitute the edges of a tetrahedron. Accordingly, a system of this type is kinematically overdetermined, but it is preferred for safety reasons. Of course, a four-sided pyramid which is formed by tensioning cables 4 and whose vertex is located on the upper frame would also be conceivable, but this configuration would allow rotation around the vertical axis, and therefore the system would be kinematically underdetermined. In the event of a failure of the vertical cable system, it could still hold the load. A kinematically determined or overdetermined solution would consist, for example, in the tensioning cables 4 not extending as far as the vertex of a pyramid but rather being attached at four points of attachment on the upper frame 2 below the level of the vertex of the pyramid.

In the specific embodiment illustrated in FIG. 3, the lower frame 2 and the upper frame 1 have a rectangular configuration, where the vertical cables 3 are attached to the vertices of the rectangle, and the cables 4 oblique to the vertical are attached to opposite lateral edges of the rectangle. One pair of cables is provided for each of two opposite sides of the rectangle, where the points of attachment 5 of the two tensioning cables 4 of each pair coincide, and the two tensioning cables extend from the common point of attachment 5 to form a V-shaped structure. The cables 4 of this pair are symmetric to the vertical plane passing through their common point of attachment 5 and through the point of attachment 5 of the other pair of cables located on the opposite side of the lower frame 2. Since in this case the lengths of the tensioning cables 4 are equal, the load is uniformly distributed over all of the tensioning cables 4 in the event of a defect or total failure of the vertical cable system.

Tensioning cables 4 of equal length also constitute a preferred embodiment for the following reason: When the tensioning cables 4 all have the same length, they can all be wound by a single drive. By contrast, if the angles to the vertical were different and therefore the cable lengths were different, then each tensioning cable 4 would have to be provided with its own drive with a different speed of rotation to prevent cables from going slack during a hoisting operation.

To prevent the load 9 from tilting sharply in the event of a failure of the vertical cable system, it is also necessary to consider the center of gravity of the structure supported by the cables. The line connecting the points of attachment 5 on the lower frame 2 preferably passes essentially through the projection of the center of gravity of the lower frame 2 onto the horizontal plane containing the points of attachment 5 (FIG. 3) or is located above the center of gravity that would be expected in the case of an unequally distributed load. In the event of a failure of the system of vertical cables 3, the tensioning cables 4 take up the load without causing pronounced rotation of the support frame 8 and its load 9. Since the center of gravity of the load 9 lies far below the lower frame 2, deviations of a few centimeters have hardly any effect. When there are several points of attachment, it is advantageous for them to be more or less uniformly distributed around the center of gravity of the lower frame 2, of the support frame 8 mounted on it, or, best of all, of the load 9 located on it. Besides, the lower frame is usually designed in such a way that its center of gravity lies well above the expected center of gravity of the load.

In many cases, it is sufficient merely to ensure that the load does not plunge to the floor, for example, in situations in which no personnel are working in the vicinity. The position of the points of attachment plays a subordinate role in these cases. To prevent the load 9 from slipping on the support frame 8, however, the center of gravity of the lower frame 2 should in any case lie within an outline formed by the vertical projection of the tensioning cables onto the plane of the lower frame 2. In another variant, the outer outline of the points of attachment 5 encloses the projection of the center of gravity of the lower frame 2 onto the horizontal plane that contains the points of attachment 5.

In another variant (not shown), the tetrahedron shown in FIG. 3 is rotated 45° around the vertical axis passing through the center of the frame rectangle, thereby moving the points of attachment 5 to the corners of the frame. This increases the obliquity of the tensioning elements, which results in better stability. Of course, space problems occur at the corners when block sheaves 10 are used, but these problems can be eliminated by slight displacement of the points of attachment 5.

Naturally, it is also possible for there to be more than four tensioning cables, e.g., eight, running along the edges of two intersecting tetrahedra. The only important consideration is that the tensioning cables must stabilize the system and be able to hold the entire load in the event of a failure of the vertical system.

In the discussion which follows, instead of using the expressions “vertical cables” and “tensioning cables oblique to the vertical”, we shall use the terms “vertical traction elements” and “tensioning elements oblique to the vertical” in order to encompass all equivalent types of traction and tensioning elements. Specifically, as is apparent from FIGS. 7-12, instead of a single fall of cable wound on a drum on the upper frame, it is also possible to use a structure similar to a block and tackle, with sheaves 10 supported on the lower frame. Of course, it is also possible to provide several windings instead of a simple block and tackle. Moreover, belts can be used just as well as cables. Therefore, the traction and tensioning elements will be either of the belt type or of the cable type. The term “belt-type or cable-type” traction and tensioning elements encompasses all of these variants in the discussion which follows.

The group consisting of tensioning elements 4 has a drive that is separate from the drive of the vertical traction elements 3. Therefore, the two groups are completely isolated from each other with respect to their drives. This does not mean that the drive for the tensioning elements 4 operates independently. It usually has to “cooperate” with the other drive and maintain the tension in the tensioning elements during the lifting and lowering of the load.

The drive of the vertical traction elements has a constant speed between the hoisting movement and the rotation of the drum 11 onto which the traction element is to be wound. Due to this linearity, it is also possible to use low-power motors. By contrast, the drive for winding the oblique tensioning elements does not have a constant speed ratio between the hoisting movement and the rotation. This does not constitute a problem, however, since the hoisting movement is carried out mainly by the drive for the vertical traction elements and only small forces need to be transmitted by the second drive during normal operation. It is only necessary to provide a control system for this drive in order to keep the tensioning elements 4 in a state of tension at all times during the lifting or lowering operation and thus to ensure the stability of the system. This can be accomplished, for example, with a two-axis control system with suitable sensors for determining the absolute position of the tensioning elements. Adjustments can be made on the basis of the movement which two elements execute relative to each other by way of a pretensioned spring, for example, and the movement can be determined by means of an inductive system. Depending on the desired movement of the tensioning elements 4, the rotational speed of the motor can be adjusted by means of a control unit. Control systems for maintaining a given (cable) tension via the rotational speed a motor are already well known to those skilled in the art and require no further explanation here.

If a failure of the system of vertical traction elements occurs, the drive for the system of tensioning elements takes over the load. The only requirements for this are tensioning elements that can withstand sufficiently large loads, a reliable gearbox, and suitably designed brakes, so that the load can be reliably prevented from falling. In this connection, it is by no means necessary for the motor to be able to lift the load.

The feature of separate drives kills two flies with one swat. The stability of a hoisting machine is increased by the use of tensioning cables, while at the same time much greater safety is provided for the workers and the load that is to be held without any appreciable increase in weight—the realization of this measure requires only an additional motor with a significantly lower output than the hoisting motor plus a drum.

A preferred embodiment of the invention will now be described. FIGS. 4, 5, and 6 show a hoisting machine with a tilted lower frame 2. In a frame of this type, two motors are provided for the system of vertical traction elements. In this connection, a separate motor is provided for each set of two traction elements of the total of four traction elements. Much like a marionette which is suspended by strings and can be brought to life by shortening and lengthening individual strings, the lower frame 2 can be tilted, e.g., to allow workers access even to poorly accessible sections of the automobile body. If, as shown in FIG. 6, the line connecting two points of attachment 5 simultaneously constitutes the axis of rotation for the tilting, it is sufficient for the system of tensioning elements to have a single motor. If this is not the case, then two or more motors may also be provided, as shown in FIGS. 10, 11, and 12. This measure ensures that none of the tensioning elements 4 loses its tension and becomes slack when the lower frame 1 is tilted. In a preferred design, all of the tensioning elements 4 thus have essentially the same length, at least when the upper frame 1 and the lower frame 2 are in a parallel position. In the embodiment shown in FIGS. 10, 11, and 12, it is possible, for example, to tilt the load around an axis parallel to the direction of travel of the hoisting machine, i.e., parallel to the rail 7.

Coming from the direction of the lower frame 2, the traction elements and tensioning elements are usually guided over guide sheaves 12 or directly onto drums 11, which are provided with grooves or guides. The drums 11 are used to wind the traction and tensioning elements and are operated by motors 13. Guide sheaves 12, drums 11, and motors 13 are supported or mounted on the upper frame 1.

The slightly oblique guidance of the vertical traction elements that is apparent in FIGS. 8 to 12 is the result of the obliquely channeled grooves in the drums 11 and consequently varies slightly during the lifting and lowering of the load.

While the attachment of the tensioning elements 4 to the lower frame 2 or the loading platform is sketched in a highly schematic way in FIGS. 1 to 6, FIGS. 13 to 15 show various detailed views of the tensioning elements terminating at a single point of attachment 5 on the lower frame 2. In the case illustrated here, the tensioning elements are simple cables, but, as noted earlier, it is also possible to use tensioning and traction elements similar to a block and tackle or tensioning and traction elements that consist of belts. FIG. 13 shows only a section of the lower frame 2, but the attachment of the other two tensioning cables on the opposite side of the lower frame is identically constructed, preferably with mirror symmetry.

The two tensioning cables 4 more or less constitute a pair of sector arms, which has the same axis. In this application, a pair of sector arms is understood to be two straight lines that lie essentially in a plane and start, at least approximately, from a single point. It is readily apparent that at their ends the two tensioning cables 4 terminate at a joint 14, which allows rotation of the lower frame 2 with respect to the tensioning cables 4 about an axis 15, which is defined by the two opposite points of attachment 5 of each set of two tensioning cables 4 on the lower frame. In the specific embodiment illustrated here, the joint is a universal joint, one axis of which is normal to the axis of rotation 15 and normal to the vertical traction elements 3, while the other axis is essentially normal to the tensioning elements 14. The ends of the tensioning elements 4 are mounted on brackets 16, which form part of the universal joint and which can rotate around the same axis. Naturally, swivel joints, ball-and-socket joints, and the like are also possible.

The imaginary extensions of the cables or the straight lines defined by the tensioning elements 4 intersect each other at a point that lies on the axis of rotation 15. Slight deviations from this requirement are permissible as long as the tensioning elements remain tautly tensioned during rotation of the lower frame. In other words, the positional changes of the ends of the tensioning elements that occur during a rotation of the lower frame must be smaller than the changes in length of the tensioning elements allowed by their natural stretch. To define a horizontal axis of rotation 15, however, the tensioning cables must be attached at least approximately to a common point on the upper frame.

The traction elements 3 are also preferably connected by universal joints, but for rotations around the axis of rotation 15, a simple swivel joint or a simple anchoring of the traction element 3 on the lower frame 2 is also sufficient.

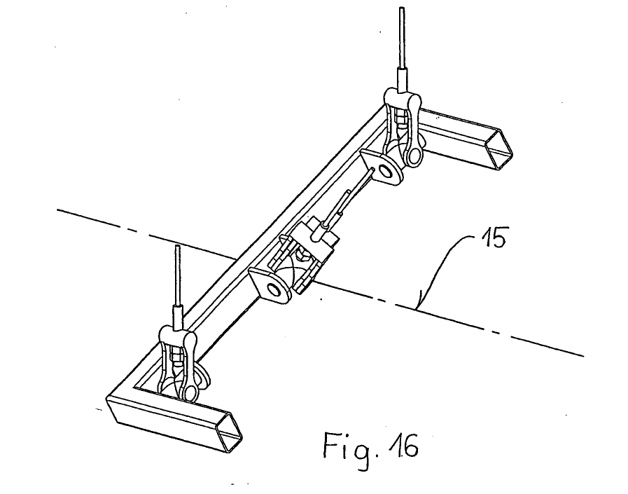

A rotation of the lower frame 2 around the horizontal axis of rotation 15 can now be carried out by operation of the traction elements 3 without it being necessary to change or adjust the length of the tensioning elements 4. This allows simple control of the hoisting machine; in particular, a single drive can be used for the four tensioning elements 4. FIG. 16 shows a frame in the rotated state. For this purpose, the length of the traction element that appears on the right in FIG. 16 must be decreased, and the length of the traction element on the left must be increased. The traction elements attached to one side of the lower frame have a drive that is independent of the drive for the traction elements attached to the other side of the lower frame.

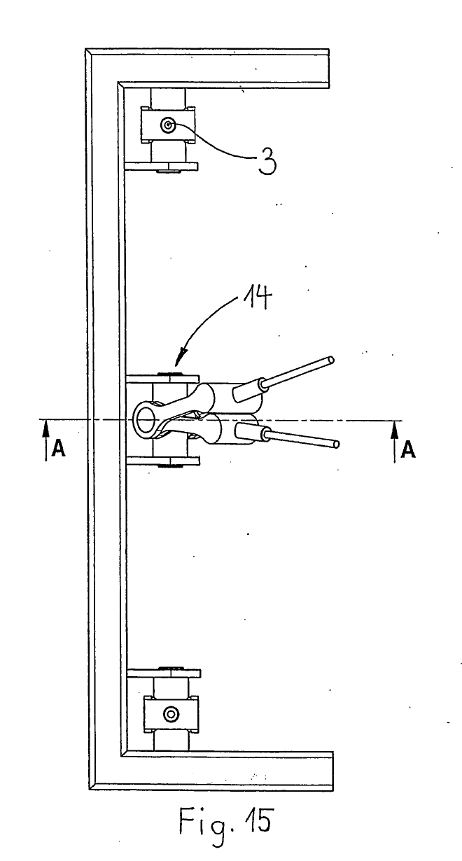

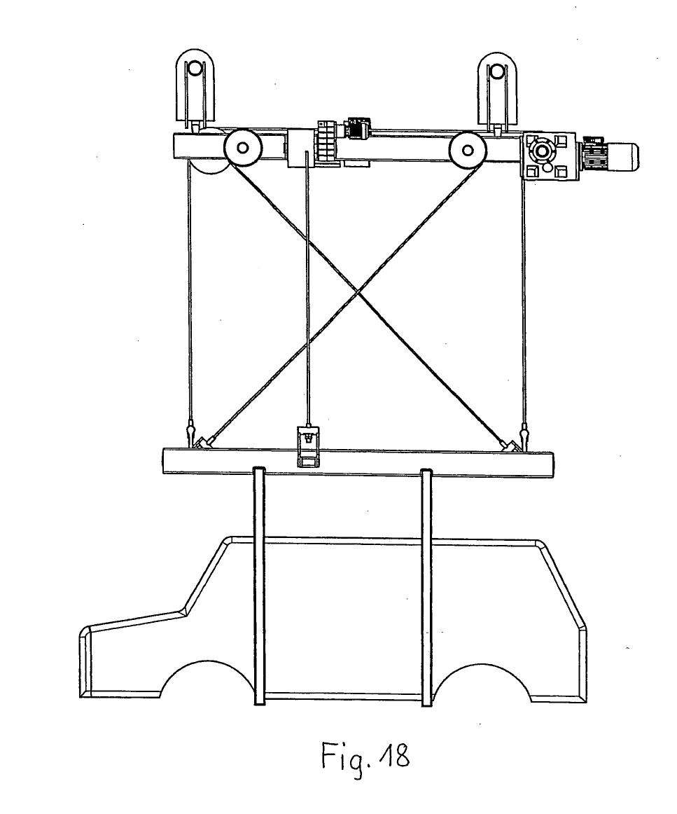

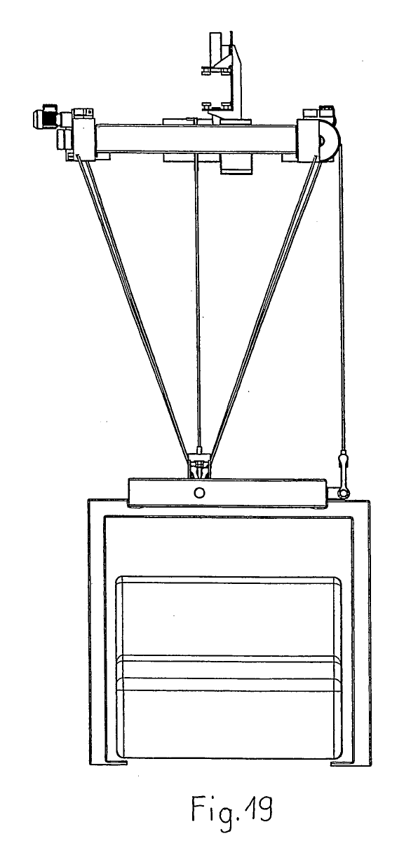

As the example in FIG. 17 shows, it is not absolutely necessary for the common point of attachment 5 of two tensioning cables 4 to be located on the lower frame midway between the points of attachment of the traction elements 3. In the embodiment of FIG. 15, the axis of rotation 15 defined by the two points of attachment 5 of the tensioning cables 4 is not located above the geometric center of gravity of the lower frame 2. It is also not absolutely necessary to use four traction cables 3. In principle, three are sufficient. Furthermore, the traction cables 3 are not positioned near the corners of the loading platform but rather form a so-called triple point together with the point of attachment 5 of two tensioning cables 4. A third traction cable is positioned a lateral distance from the axis of rotation 15 in the area of the outer surface of the lower frame 2. The reason that this embodiment is preferred, is that to rotate the load, it is necessary to operate only this one laterally separated traction cable, which for this purpose also has its own drive. FIGS. 18 and 19 show a side view and a front view of the inventive hoisting machine.

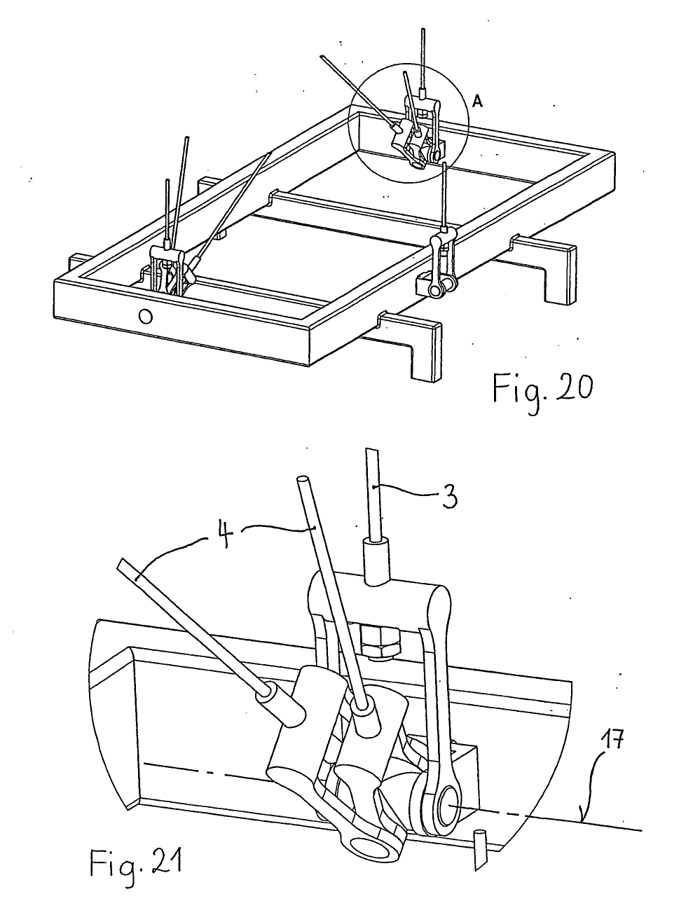

FIGS. 20 and 21 show detail views of how the tensioning elements and traction elements can be connected at the triple point. As in FIG. 13, this joint is a universal joint, where the traction element 3 is connected to the lower frame 2 by an axis 17 that is identical to one of the axes of the universal joint.

FIGS. 22 to 25 show the inventive hoisting machine with the lower frame 2 rotated. In this preferred embodiment, to arrive in the rotated state, it is necessary to operate only the traction element that is laterally separated from the axis of rotation 15. The length of all of the other traction and tensioning elements remains constant. As is apparent from the detail views, the joint at the triple point is connected to the lower frame in such a way that the lower frame can rotate with respect to the joint around the axis of rotation 15. So that rotation can be carried out in the other direction as well, a fourth traction element can be provided, which would be attached to the opposite side of the lower frame.

It is not absolutely necessary for the axis of rotation 15 defined by the points of attachment 5 of the tensioning cables 4 to be parallel to the longitudinal axis of the vehicle. In principle, any orientation is possible, but only rotation around the longitudinal axis of the vehicle is important especially in vehicle final assembly, and only rotation transversely to the longitudinal axis of the vehicle is important in vehicle dip coating.

Naturally, in addition to the design that has been described, additional traction elements and tensioning elements can be provided to increase safety or improve stability. In this regard, the reader is referred to the first part of the specification.

FIG. 26 shows a preferred modification of the invention. In this connection, we should first say a few words about the drive. During the lifting and lowering of the lower frame, cables of the traction and tensioning elements are wound onto and unwound from motor-driven drums. In the case in which only one hoisting movement is provided, it is sufficient if the traction elements and the tensioning elements are each provided with their own drive unit. The drums for the traction elements and the drums for the tensioning elements are connected mechanically to each other with respect to rotational movement. In cases where rotation around a horizontal axis is to be allowed in addition to the lifting movement, two drum drives that are mechanically independent of each other are needed for the traction elements. See, for example, FIG. 17: a motor 30 for the two cables that terminate at the triple points and a motor 30′, which is independent of the motor 30, for the laterally positioned cable.

As previously mentioned, it is necessary to keep the tensioning elements under continuous tension to make the hoisting machine insensitive to transverse forces. The initial stressing force must be greater than the transverse forces acting on the lower frame. In the present invention, it is necessary merely to keep the two pairs of sector arms taut. This requires that they always be lengthened or shortened to the same extent.

Another consideration in this connection concerns the use of contactless current transmission systems, which, to be sure, are being used more and more in the automobile industry but which become disproportionately expensive at high current levels. Therefore, it makes sense to use energy storage devices.

Finally, it is necessary to increase the safety of the system, since workers are working at or under these hoist suspensions. Failure of one of the system components (e.g., the drive motor) should not give rise to dangerous conditions for workers.

The modification shown schematically in FIG. 26 combines these aspects in an extremely elegant way. It is explicitly noted that the following discussion does not apply solely to the illustrated combinations and arrangements of traction elements and tensioning elements. The use of the pressure accumulator described below is equally possible in all applications involving the lifting and lowering of loads.

18 designates a motor-driven drum for traction elements (for the sake of clarity, the motor is not shown, but its action is indicated by the circular arrow). The drum 18 is connected nonrotatably to a threaded nut 19. As the drum 18 turns, the threaded nut 19 moves a threaded spindle 20, which is prevented from rotating. The threaded spindle 20 in turn acts on the piston of a hydraulic cylinder 21, which, for the purpose of storing energy, delivers its contents to a prepressurized storage device 22, e.g., a bubble accumulator, piston accumulator, diaphragm accumulator, spring accumulator, or the like. The energy otherwise wasted during the downward movement is stored in the storage device and then reused when the load is lifted. In addition to the essentially incompressible pressure medium, the storage device contains compressible or elastic media, which are able to absorb or damp shocks.

If, as in the case of rotation, two or more independently driven drums are provided for two or more groups of traction cables, correspondingly more drum units can be connected to the pressure accumulator. Two such drum units are shown in FIG. 30.

Several variants described below can be realized independently of one another or also simultaneously to pursue one or more of the aforementioned purposes:

Between the cylinder 21 and the pressure accumulator 22, a valve 23 is installed, e.g., a 2/2-port directional control valve, which closes the connection of the cylinder 21 to the pressure accumulator 22 in the event of a shutdown and at the same time acts as a hydraulic brake. In addition, a safety circuit 24 consisting of, for example, a throttle together with a pressure-head indicator or a flow meter, is provided between the cylinder 21 and the pressure accumulator 22. If the pressure head is too high or the velocity of the pressure medium in the pressure line is too high, which corresponds to an increased speed of the lower frame, the valve is closed and thus the hoisting movement is reliably terminated. The dotted line is a schematic representation of a control line to the valve 23, which delivers suitable information with respect to the flow of pressure medium between the cylinder and pressure accumulator.

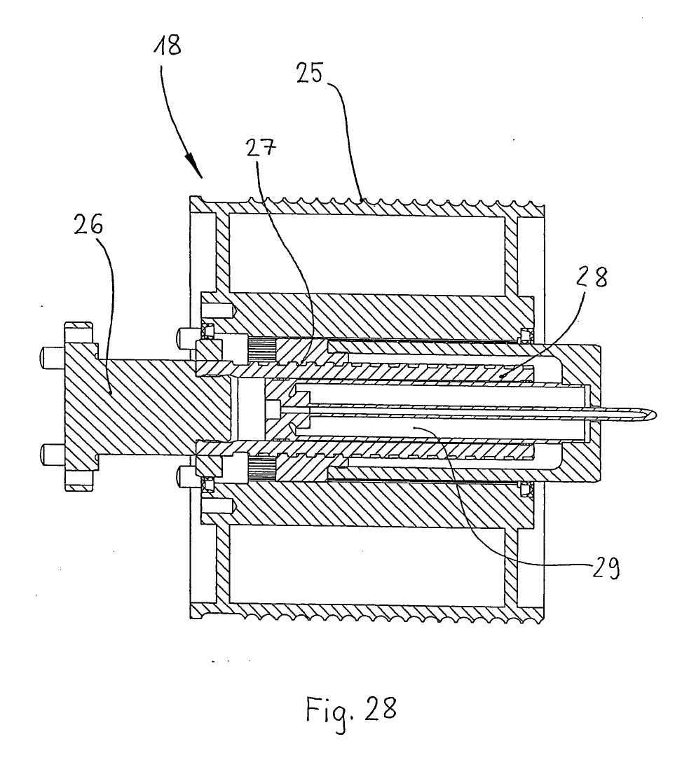

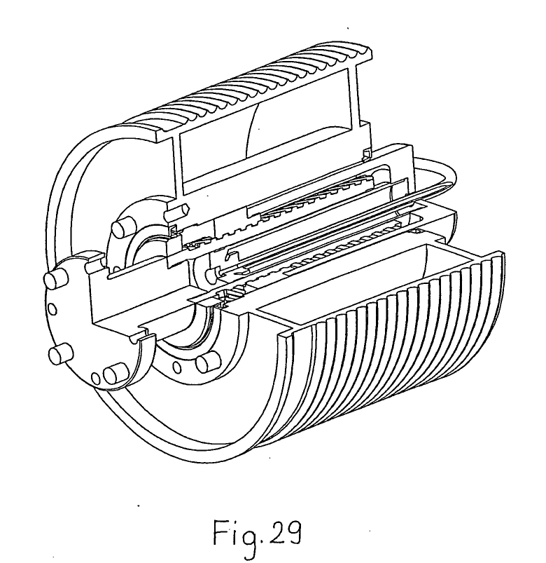

FIGS. 27 to 29 show a possible embodiment of a drum, in the interior of which the hydraulic cylinder is integrated. The helical grooves for the traction or tensioning cables are designated 25. The cross-sectional view of FIG. 28 shows the connecting device 26 for a motor, the spindle nut 27, which acts on the spindle 28, and the hydraulic cylinder 29, the piston of which is moved by the spindle 28 when the drum 18 rotates. Naturally, it is possible to use other mechanisms for translating rotational motion into translational motion that are well known to the expert.

In the example shown in FIG. 17, the drums from which the tensioning cables 4 are unwound are mechanically connected to each other with respect to their rotation. Accordingly, their lengths can only be changed to the same extent. Therefore, only a single cylinder is provided for this case in FIGS. 26 and 30. It would also be possible, however, to connect several mechanically connected and therefore synchronous drums to the drum 32 shown in the drawings (indicated in FIG. 17).

In embodiments other than the preferred embodiment shown in FIG. 17, in which several tensioning elements that can be operated independently of one another are provided (in order, for example, to allow rotation in other horizontal axes), it is also possible, of course, to connect each group of independently operated tensioning cables to the pressure accumulator by its own hydraulic cylinder.

It is important to note that it is not absolutely necessary to have different hydraulic cylinders leading to the same pressure accumulator. To achieve efficient damping of shocks, each driven drum or group of drums could have its own pressure accumulator separate from the others.

During the downward movement of the lower frame 2, while the pistons of the cylinders 21, 21′ are forcing the pressure medium into the pressure accumulator, pressure energy is produced and stored and is then available again during the upward movement of the load to assist the motor. At the same time, the pressure energy is transmitted (an open valve 33 is assumed) to the drum 32 or drums of the tensioning cables, and the drum or drums are driven in this way and keep the tensioning cables under continual tension.

As in previous embodiments, the drives for traction elements and tensioning elements in the embodiment described above are mechanically independent of one another, i.e., the drive energy needed to carry out rotational movements is made available entirely by a single motor.

As mentioned above, the use of a pressure accumulator is not limited to a system of the type illustrated in FIG. 17. Any conceivable arrangement, number, and combination of traction cables and possibly tensioning cables can be improved with respect to its damping properties by the use of a pressure accumulator.

Since power consumption is increasing due to heavier loads and growing dead weight of hoisting machines, and since the requirement of rapid load movement must be met, the design in accordance with the invention is a cost-reducing and energy-saving measure.

Another advantageous effect of this design is that strong shocks, collisions, and the like can be absorbed by the hydraulic system. In this connection, the pressure accumulator acts as a buffer and protects the entire structure from damage.

Naturally, all of the elements described above can be used by themselves. For example, only the drums for the tensioning cables or only the drums for the traction cables could be connected to a pressure accumulator, etc.

The measure of the invention makes it possible (and this works only with the use of tensioning cables combined into pairs of sector arms) to construct a hoisting machine for the automobile industry which is light, stable, inexpensive, and safe and which, above all, can be rotated around a horizontal axis without significant added expense.

1. A hoisting machine, especially for the automobile industry, with an upper frame (1) and a lower frame (2) positioned below it, where the lower frame (2) is held on the upper frame (1) by at least three essentially vertical traction elements (3) and at least four tensioning elements (4) that run obliquely to the vertical and can be moved vertically by driving the traction elements (3) and tensioning elements (4), and where pairs of tensioning elements (4) are attached, at least approximately, to a common point (5) on the lower frame (2), wherein the ends of the two tensioning elements (4) terminate at a joint (14), which is connected to the lower frame (2) and allows rotation of the lower frame (2) relative to the tensioning elements (4) around an axis of rotation (15) which is defined by the two points of attachment (5) of the tensioning cables (4) to the lower frame (2).

2. A hoisting machine according to claim 1, wherein a traction element (3) is attached, at least approximately, to each of the two points of attachment (5) that define the axis of rotation (15) and forms a triple point together with two tensioning elements (4) attached to each point of attachment (5).

3. A hoisting machine according to claim 1, wherein, to allow the tilting of the lower frame (2), at least one vertical traction element (3) has a drive that is independent of the other vertical traction elements.

4. A hoisting machine according to claim 1, wherein the system consisting of the upper frame (1), the lower frame (2), the traction elements (3), and the tensioning elements (4) is kinematically determined and preferably kinematically overdetermined.

5. A hoisting machine according to claim 1, wherein the line connecting the two points of attachment (5) of the tensioning elements (4) passes essentially through the vertical projection of the center of gravity of the lower frame (2) onto the horizontal plane that contains the points of attachment.

6. A hoisting machine according to claim 1, wherein the outline of the tensioning elements (4) vertically projected onto the horizontal plane of the center of gravity of the lower frame (2) contains the center of gravity of the lower frame (2).

7. A hoisting machine according to claim 1, wherein four tensioning elements (4) are provided, which extend from the upper frame (1) to the lower frame (2) essentially along the edges of a preferably regular tetrahedron.

8. A hoisting machine according to claim 1, wherein all of the tensioning elements (4) have essentially the same length, at least when the upper frame (1) and the lower frame (2) are in a parallel position.

9. A hoisting machine according to claim 1, wherein the drive of the traction elements (3) is hydraulically connected to a pressure accumulator (22) via a hydraulic cylinder (21, 21′).

10. A hoisting machine according to claim 9, wherein the tensioning elements (4) are hydraulically powered by the pressure energy stored in the pressure accumulator (22).

11. A hoisting machine according to claim 9, wherein a safety circuit, which closes the pressure line when a certain fluid flow is exceeded, is provided between the hydraulic cylinder (21, 21′) and the pressure accumulator (22).

12. A hoisting machine, especially for the automobile industry, with an upper frame (1) and a lower frame (2) positioned below it, where the lower frame (2) is held on the upper frame (1) by traction elements (3) and possibly by tensioning elements (4) that run obliquely to the vertical and can be moved vertically by driving the traction elements (3) and possibly by tensioning elements (4), wherein the drive of one or more traction elements (3) is hydraulically connected to a pressure accumulator (22).

13. A hoisting machine according to claim 12, wherein the drive of one or more tensioning elements (4) is hydraulically connected to a pressure accumulator (22).

14. A hoisting machine according to claim 13, wherein the drive of the traction elements (3) and the drive of the tensioning elements (4) are connected to the same pressure accumulator (22).

15. A hoisting machine according to claim 12, wherein the traction elements (3) and possibly the tensioning elements (4) are driven by one or more drums (18, 18′, 32), where the rotational motion of the drums acts on the piston of a hydraulic cylinder (21, 21′, 31) via a spindle (20) and vice versa.

16. A hoisting machine according to claim 12, wherein a safety circuit, which closes the pressure line when a certain fluid flow is exceeded, is provided between the hydraulic cylinder and the pressure accumulator (22).
